(19) United States
(12) Patent Application Publication
(10) Pub. No.: US 2019/0084530 A1
(43) Pub. Date: Mar. 21, 2019

(54) VEHICLE CLEANING APPARATUS

(71) Applicant: KOITO MANUFACTURING CO., LTD., Tokyo (JP)

(72) Inventors: Hiroaki KIMURA, Shizuoka-shi (JP); Masaru SAKAI, Shizuoka-shi (JP)

(73) Assignee: KOITO MANUFACTURING CO., LTD., Tokyo (JP)

(21) Appl. No.: 16/134,324

(22) Filed: Sep. 18, 2018

(30) Foreign Application Priority Data
Sep. 19, 2017 (JP) 2017-178865

(51) Int. Cl. B60S 1/52; B60S 1/54; B60S 1/56

(52) U.S. Cl. CPC B60S 1/52; B60S 1/56; B60S 1/54

(57) ABSTRACT

A vehicle cleaning apparatus includes a nozzle configured to jet fluid toward an object to be cleaned; a cover configured to cover at least a part of the nozzle; a valve configured to open and close a channel of the fluid; and a holder including a valve disposition portion in which at least a part of the valve is disposed, and a cover attachment portion to which the cover is attached. The cover attachment portion is formed integrally with the valve disposition portion.

### INCORPORATION BY REFERENCE

The disclosure of Japanese Patent Application No. 2017-178865 filed on Sep. 19, 2017 including the specification, drawings and abstract is incorporated herein by reference in its entirety.

### BACKGROUND

### 1. Technical Field

The disclosure relates to a vehicle cleaning apparatus that cleans an object to be cleaned by jetting fluid from a nozzle toward the object to be cleaned.

### 2. Description of Related Art

For example, there is a vehicle cleaning apparatus that is partially projected to the outside from an opening provided in a vehicle body or a bumper, and jets fluid from a nozzle to clean an object to be cleaned such as a vehicular lamp, a camera, or a radar.

An example of the vehicle cleaning apparatus includes a nozzle that is provided on a distal side and jets fluid; a valve disposition member in which a valve is disposed in a channel of the fluid; and an attachment member to which a cover is attached, the cover being provided to open and close an opening of a bumper or the like (for example, see Japanese Patent Application Publication No. 2009-83714 (JP 2009-83714 A)). In JP 2009-83714 A, the valve disposition member is described as a “nozzle portion”, and the attachment member is described as a “holder”.

In such a vehicle cleaning apparatus, when the fluid is supplied to the channel, the valve is operated to open the channel, and the fluid flows toward the nozzle and is jetted from the nozzle.

### SUMMARY

The vehicle cleaning apparatus described in JP 2009-83714 A includes the nozzle portion in which the valve is disposed, the holder which is coupled to the nozzle portion and to which the cover is attached, and the like. Thus, the vehicle cleaning apparatus has the large number of components. Accordingly, it is difficult to reduce the size of the vehicle cleaning apparatus. In addition, man-hours required for assembly of the components may increase.

The disclosure provides a vehicle cleaning apparatus that makes it possible to reduce the number of components and to simplify a structure thereof.

An aspect of the disclosure relates to a vehicle cleaning apparatus including a nozzle configured to jet fluid toward an object to be cleaned; a cover configured to cover at least a part of the nozzle; a valve configured to open and close a channel of the fluid; and a holder including a valve disposition portion in which at least a part of the valve is disposed, and a cover attachment portion to which the cover is attached. The cover attachment portion is formed integrally with the valve disposition portion.

With the above-described configuration, in the holder, the valve disposition portion, in which the valve is disposed, and the cover attachment portion, to which the cover is attached, are integrally formed.

The vehicle cleaning apparatus according to the above-described aspect may further include a piston which is movable in an axial direction with respect to a cylinder and in which the fluid flows. The holder may further include a piston coupling portion that is coupled to the piston; and the valve disposition portion and the piston coupling portion may be integrally formed.

With the above-described configuration, a dedicated member in which the valve is disposed and a dedicated member which is coupled to the piston are unnecessary.

In the above-described aspect, the holder may further include a nozzle holding portion configured to hold the nozzle; the valve disposition portion and the piston coupling portion may be provided to be continuous with each other in the axial direction; and the nozzle holding portion may be projected from the valve disposition portion in a different direction from the axial direction.

With the above-described configuration, the direction in which the nozzle holding portion is projected is different from the axial direction in which the valve disposition portion and the piston coupling portion are continuous with each other

In the above-described aspect, a plurality of the nozzle holding portions and a plurality of the nozzles may be provided; and the plurality of the nozzle holding portions may be projected from the valve disposition portion toward opposite sides in a direction orthogonal to the axial direction.

With the above-described configuration, since the plurality of the nozzles are provided, the fluid can be jetted to a wide area.

In the above-described aspect, a part of the valve may be disposed in the piston coupling portion.

With the above-described configuration, the valve is disposed to extend from the valve disposition portion to the piston coupling portion (in other words, a part of the valve is disposed in the valve disposition portion and another part of the valve is disposed in the piston coupling portion).

In the above-described aspect, an air flow hole may be provided, and outside air may be taken into the holder through the air flow hole to cause the valve to operate; and the air flow hole may be covered by the cover.

With the above-described configuration, dust and moisture that move toward the air flow hole can be blocked by the cover.

According to the above aspect of the disclosure, since the valve disposition portion, in which the valve is disposed, and the cover attachment portion, to which the cover is attached, are integrally formed in the holder, a dedicated member to which the cover is attached and a dedicated member in which the valve is disposed are unnecessary. Therefore, the number of components can be reduced, and the structure can be simplified.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows a vehicle cleaning apparatus according to an embodiment of the disclosure together with FIG. 2 to FIG. 5, and is a perspective view of the vehicle cleaning apparatus;

FIG. 2 is a vertical sectional view of the vehicle cleaning apparatus in a state where an opening of a bumper is closed by a cover;

FIG. 3 is a horizontal sectional view showing a state where a channel is closed by a valve;

FIG. 4 is a perspective view showing a state where a piston is moved forward; and

FIG. 5 is a horizontal sectional view showing a state where the valve is moved to open the channel.

### DETAILED DESCRIPTION OF EMBODIMENTS

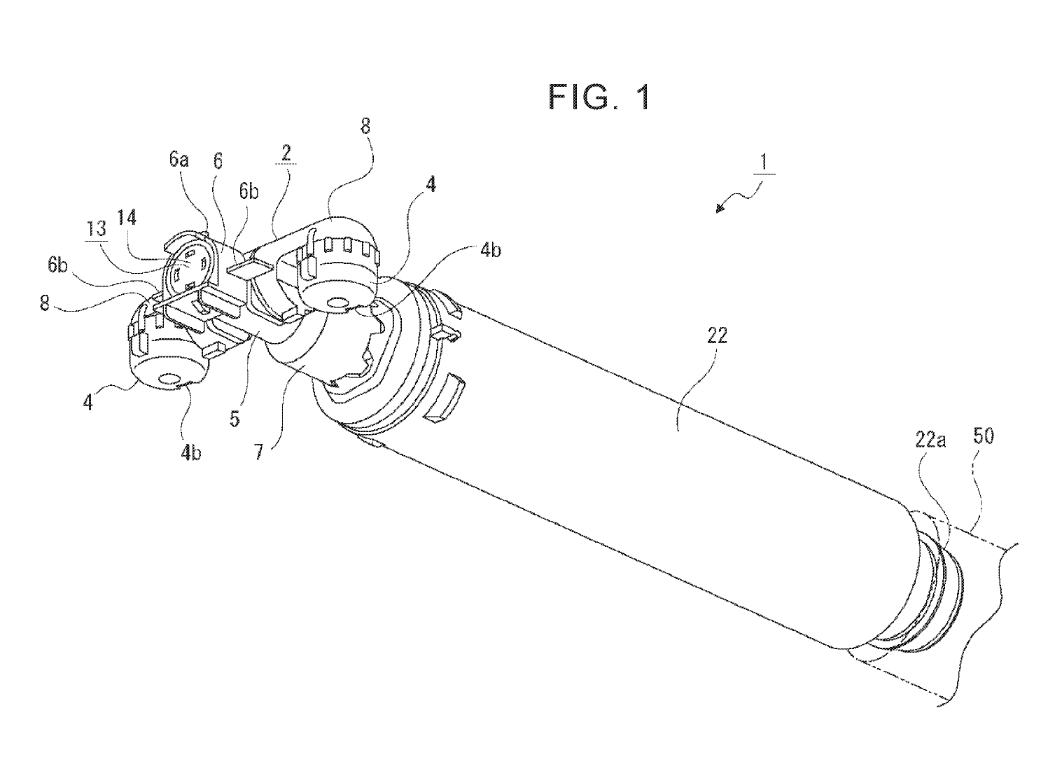

A vehicle cleaning apparatus according to an embodiment of the disclosure will be described with reference to the accompanying drawings (see FIG. 1 to FIG. 5). Note that the vehicle cleaning apparatus described below can be widely applied to vehicle cleaning apparatuses used for cleaning parts provided in a vehicle such as a vehicle body, a window, and a mirror, in addition to a vehicular lamp, a camera, and a radar.

The vehicle cleaning apparatus described below includes a piston and a cylinder and is configured such that the piston moves with respect to the cylinder. In the following description, a moving direction of the piston is set as a front-rear direction, and accordingly, the front-rear direction, an up-down direction, and a right-left direction are described based on the moving direction of the piston. Note that the front-rear direction, the up-down direction, and the right-left direction are described for the sake of convenience, and the directions are not limited thereto when the disclosure is implemented.

A vehicle cleaning apparatus 1 includes a holder 2, a cover 3, and nozzles 4 (see FIG. 1 to FIG. 3).

The holder 2 includes a substantially cylindrical valve disposition portion 5 whose axial direction extends in the front-rear direction; a cover attachment portion 6 that is continuous with a front end of the valve disposition portion 5; a piston coupling portion 7 that is continuous with a rear end of the valve disposition portion 5; and nozzle holding portions 8 that are projected toward opposite sides from the valve disposition portion 5.

A curved surface 5a is formed at a position near a rear end in an inner portion of the valve disposition portion 5. The curved surface 5a extends (curves) inward in a direction toward a rear side. A rear edge of the curved surface 5a in the valve disposition portion 5 is formed so as to define an opening 5b. In an internal space of the valve disposition portion 5, a portion located behind the opening 5b is formed as an insertion space 5c having a constant diameter.

The cover attachment portion 6 is formed to have a substantially cylindrical shape, and an axial direction of the cover attachment portion 6 extends in the front-rear direction. A diameter of the cover attachment portion 6 is slightly larger than the diameter of the front end of the valve disposition portion 5. The cover attachment portion 6 is continuous with an outer peripheral surface of the front end of the valve disposition portion 5 and is projected forward from the valve disposition portion 5. The valve disposition portion 5 and the cover attachment portion 6 are integrally formed (in other words, the valve disposition portion 5 is integral with the cover attachment portion 6).

An attachment engagement portion 6a that is projected upward is provided on an upper end of the cover attachment portion 6. On each of right and left ends of the cover attachment portion 6, a positioning engagement portion 6b that is projected toward a right side or a left side is provided.

The piston coupling portion 7 is formed to have a substantially cylindrical shape, and an axial direction of the piston coupling portion 7 extends in the front-rear direction. The piston coupling portion 7 is projected rearward from a rear end of the valve disposition portion 5. The piston coupling portion 7 is formed integrally with the valve disposition portion 5. Thus, in the holder 2, the valve disposition portion 5, the cover attachment portion 6, and the piston coupling portion 7 are integrally formed.

The nozzle holding portions 8 are respectively projected toward the right side and the left side from a substantially rear half portion of the valve disposition portion 5. Each of the nozzle holding portions 8 is a member formed separately from the valve disposition portion 5. However, the nozzle holding portions 8 may be formed integrally with the valve disposition portion 5.

The nozzles 4 are respectively held at distal ends of the nozzle holding portions 8. Each nozzle 4 may be fixed to the corresponding nozzle holding portion 8 or may be rotatably supported by the corresponding nozzle holding portion 8.

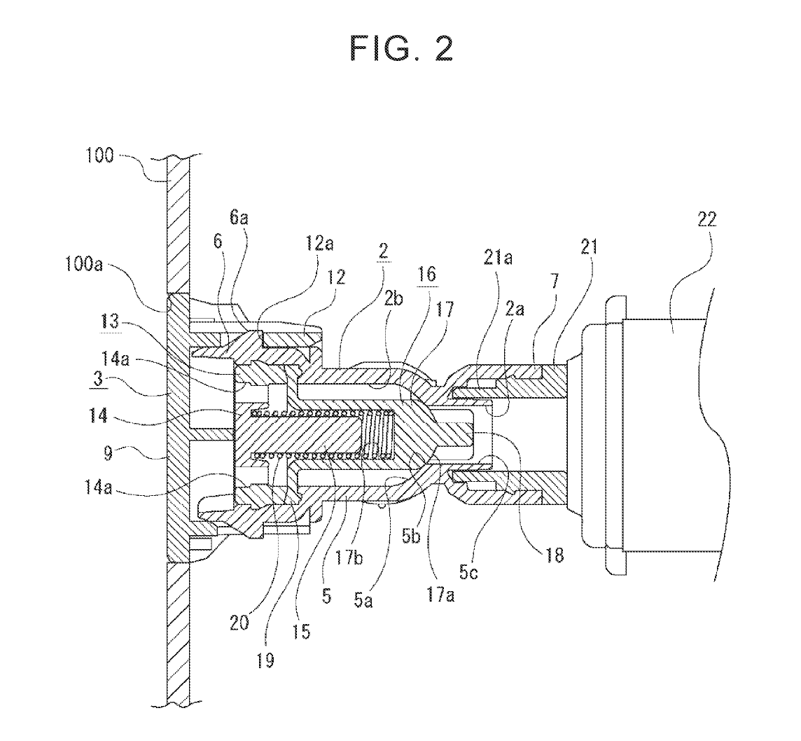

The cover 3 includes a cover surface portion 9, shielding portions 10, positioning portions 11, and an engagement portion 12 (see FIG. 2 to FIG. 4). The cover surface portion 9 is formed to have a plate shape that faces in the substantially front-rear direction. The shielding portions 10 are projected rearward from positions near right and left ends of the cover surface portion 9, respectively. The positioning portions 11 are projected rearward from the cover surface portion 9 and are positioned apart from each other in the right-left direction. Each of the positioning portions 11 is positioned inward of a corresponding one of the shielding portions 10. The positioning portions 11 have respective insertion cut portions 11a that are opened toward the rear side and toward the right and left sides. The engagement portion 12 is projected rearward from a position near an upper end of the cover surface portion 9 and has an engagement hole 12a that extends through the engagement portion 12 in the up-down direction.

The cover 3 is attached to the cover attachment portion 6 in a state where the positioning engagement portions 6b of the cover attachment portion 6 are respectively inserted in the insertion cut portions 11a of the positioning portions 11 and the attachment engagement portion 6a of the cover attachment portion 6 is engaged with an opening edge defining the engagement hole 12a in the engagement portion 12.

A cap 13 that closes a front opening of the valve disposition portion 5 is attached to an inner peripheral surface of the cover attachment portion 6. The cap 13 is provided with a substantially disc-shaped closing portion 14; and a spring support portion 15 that is projected in the front-rear direction from a central portion of the closing portion 14. The closing portion 14 has air flow holes 14a each of which extends through the closing portion 14 in the front-rear direction. The cap 13 is attached to the holder 2 in a state where the closing portion 14 closes the front opening of the valve disposition portion 5.

A valve 16 is disposed in the holder 2. The valve 16 is formed of an elastically deformable material such as rubber. The valve 16 is elastically deformable. The valve 16 is disposed in the valve disposition portion 5 except a rear end of the valve 16, and the rear end of the valve 16 is disposed in the piston coupling portion 7. However, the entire valve 16 may be disposed in the valve disposition portion 5.

The valve 16 includes an opening-closing portion 17 that extends in the front-rear direction; a projected portion 18 that is projected rearward from the opening-closing portion 17; and a flange-shaped attached portion 19 that protrudes outward from a front end of the opening-closing portion 17. An outer peripheral surface of a rear end of the opening-closing portion 17 is formed as a pressing surface 17a that is a curved surface projected rearward. The pressing surface 17a has substantially the same curvature as that of the curved surface 5a of the valve disposition portion 5. The opening-closing portion 17 has a disposition space 17b that is opened forward. A front edge of the projected portion 18 matches a rear edge of the pressing surface 17a, and a diameter of the projected portion 18 is smaller than a maximum diameter of the opening-closing portion 17.

The valve 16 is disposed in the holder 2 such that an outer periphery of the attached portion 19 is held between a front end surface of the valve disposition portion 5 and the closing portion 14 of the cap 13 in the front-rear direction. In the valve 16, the attached portion 19 is elastically deformable in a direction in which the opening-closing portion 17 and the projected portion 18 move in the front-rear direction (i.e., in the axial direction).

The valve 16 is urged by an urging spring 20 in a direction in which the pressing surface 17a is pressed against the curved surface 5a of the valve disposition portion 5. The urging spring 20 is, for example, a compression coil spring, and is inserted in the disposition space 17b of the valve 16 except a front end of the urging spring 20. The spring support portion 15 of the cap 13 is inserted in the urging spring 20, and both of front and rear ends of the urging spring 20 are pressed against the closing portion 14 of the cap 13 and the valve 16, respectively.

In a state where a forward moving force is not applied to the valve 16, the pressing surface 17a is pressed against the curved surface 5a, the opening 5b is closed by the opening-closing portion 17, and the entire projected portion 18 is inserted in the insertion space 5c.

In a state where the valve 16 is disposed in the holder 2, an internal space of the holder 2, which is located behind the opening-closing portion 17 of the valve 16, is set as a first channel 2a, and the internal space of the holder 2, which is located behind the attached portion 19 of the valve 16 and ahead of the first channel 2a, is set as a second channel 2b.

The piston coupling portion 7 of the holder 2 is coupled to a piston 21. A front end of the piston 21 is provided as a coupling cylindrical portion 21a. The piston coupling portion 7 of the holder 2 is coupled to the coupling cylindrical portion 21a.

The piston 21 is supported by a cylinder 22 such that the piston 21 is movable in the front-rear direction (i.e., in an axial direction of the piston 21) (see FIG. 1). An unillustrated spring member, for example, a tension coil spring is disposed in the piston 21. One end of the spring member is supported by the piston 21, and the other end thereof is supported by the cylinder 22. Thus, an urging force in a direction in which the piston 21 is pulled into the cylinder 22 is applied to the piston 21 by the spring member. In a state where fluid is not supplied to the inside of the piston 21, the piston 21 is located at a rear end of a movement range.

A rear end of the cylinder 22 is provided as a supply pipe coupling portion 22a. A supply pipe 50 is coupled to the supply pipe coupling portion 22a. The fluid is supplied to the supply pipe 50 from a supply tank, and the supplied fluid flows toward the nozzles 4 from the internal space of the piston 21 via the first channel 2a and the second channel 2b of the holder 2.

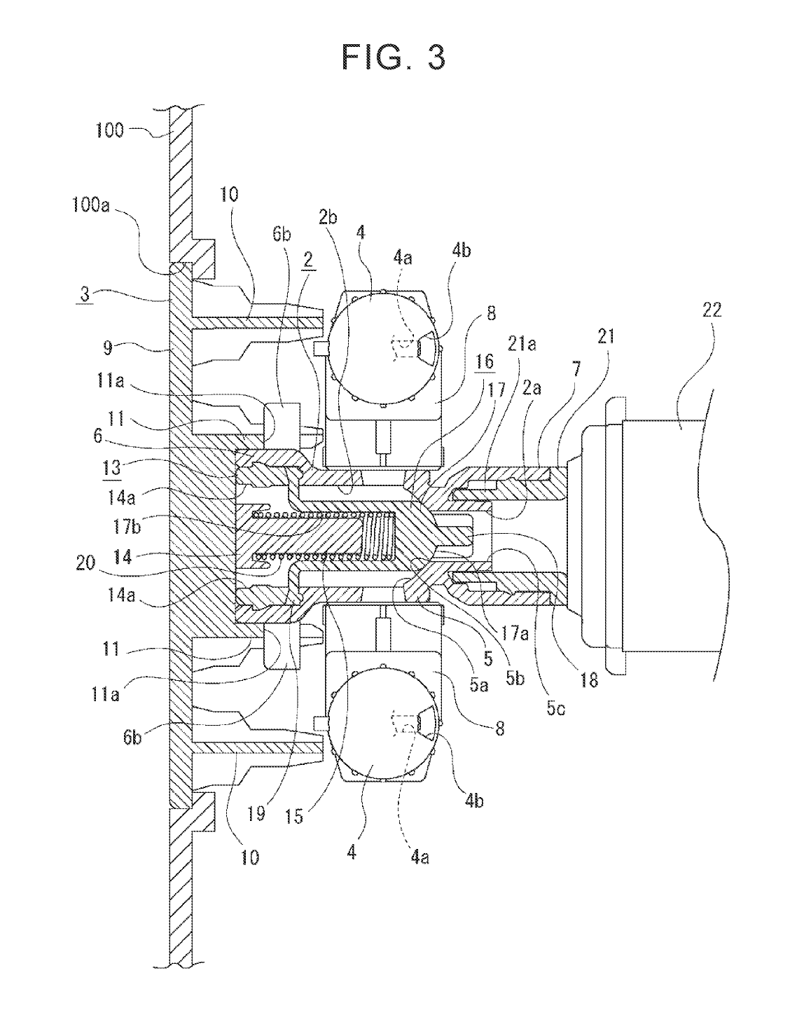

In the vehicle cleaning apparatus 1, in a state where the cover 3 is attached to the cover attachment portion 6 of the holder 2 and the piston 21 is located at the rear end of the movement range with respect to the cylinder 22, the cover surface portion 9 of the cover 3 is positioned so as to close an opening 100a formed in a bumper 100 or the like (see FIG. 2 and FIG. 3).

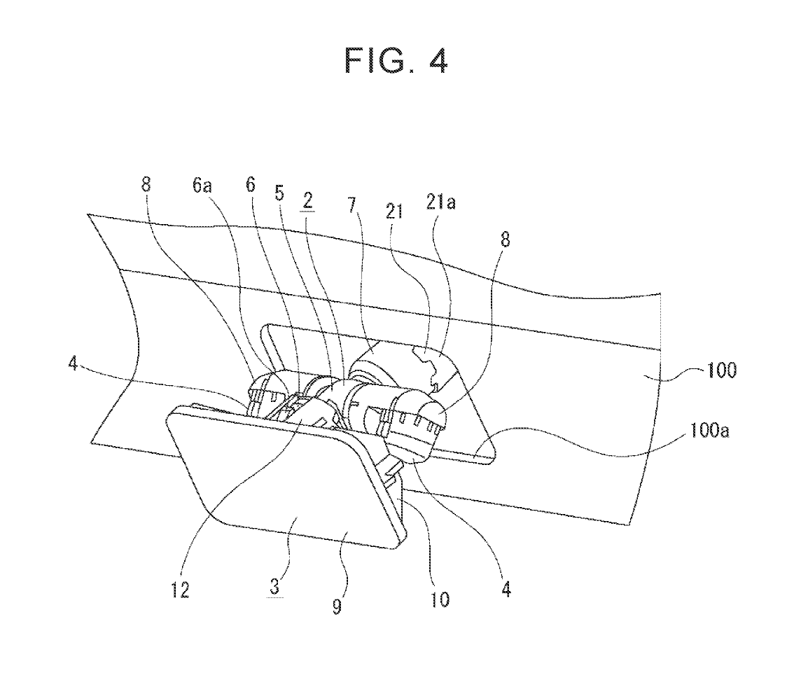

In addition, in the state where the cover 3 is attached to the cover attachment portion 6, the air flow holes 14a formed in the cap 13 are covered by the cover surface portion 9 from the front side. In the vehicle cleaning apparatus 1 that is configured as described above, when the fluid is supplied from the supply tank to the inside of the piston 21 via the supply pipe 50, the fluid flows toward the valve 16. Then, due to a pressure of the fluid, the piston 21, the holder 2, and the cover 3 integrally move in a direction so as to be projected from the cylinder 22 (in other words, the piston 21, the holder 2, and the cover 3 move forward together) against the urging force of the spring member. The piston 21 moves to a front end of the movement range, and the nozzles 4 of the holder 2 are positioned in front of the bumper 100 (see FIG. 4).

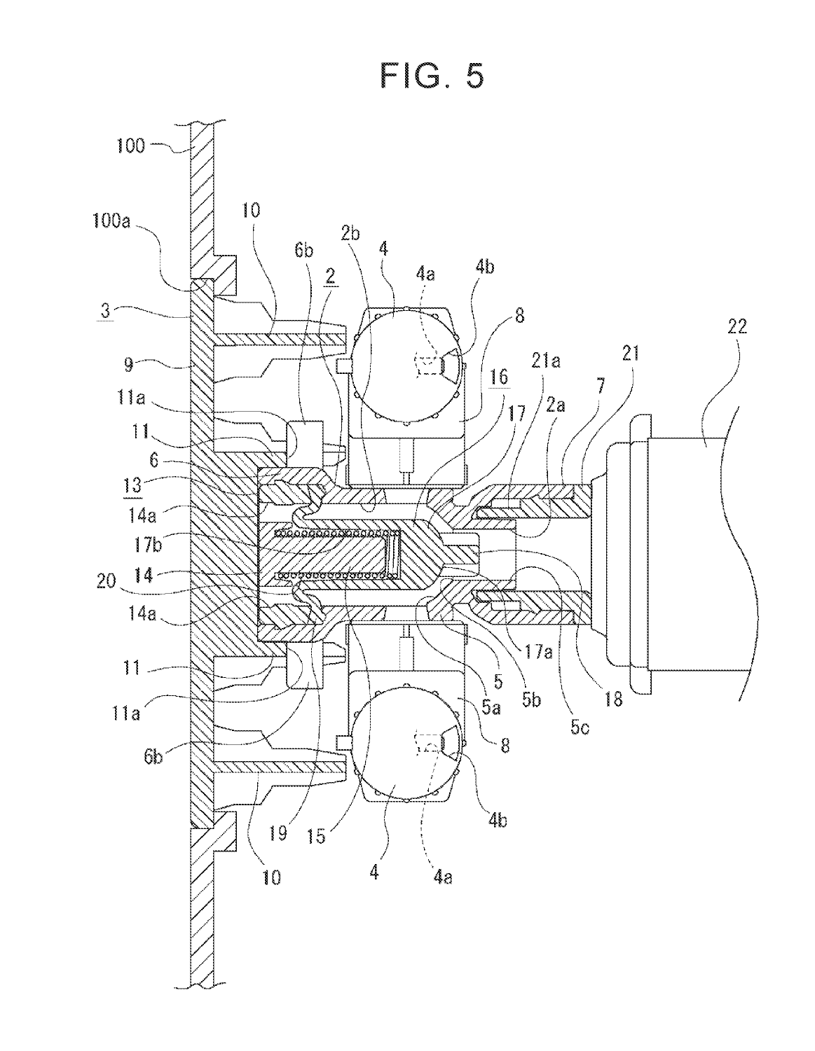

At this time, outside air is taken through the air flow holes 14a of the cap 13 into a space in front of the valve 16 in the holder 2. Since the fluid flows toward the valve 16, a pressure (an internal pressure) in the first channel 2a becomes higher than the atmospheric pressure. Accordingly, the attached portion 19 of the valve 16 is elastically deformed, and the valve 16 moves forward against the urging force of the urging spring 20 (see FIG. 5). Then, the pressing surface 17a of the opening-closing portion 17 moves away from the curved surface 5a of the holder 2, and thus, the opening 5b is opened. The fluid flows through the opening 5b and the second channel 2b from the first channel 2a, and then flows toward the nozzles 4. At this time, the fluid flows toward the nozzles 4 along an outer peripheral portion of the valve 16.

As described above, in the vehicle cleaning apparatus 1, the urging spring 20 is provided in the inside of the valve 16, and the fluid flows in an area outside the valve 16. Thus, the flow of the fluid is not hindered by the urging spring 20, and thus, it is possible to ensure a smooth flow of the fluid.

The fluid, which has flowed toward the nozzles 4, flows into discharge spaces 4a, and is jetted from discharge ports 4b toward an object to be cleaned such as a vehicular lamp. Thus, the object is cleaned by the jetted fluid. When the supply of the fluid from the supply tank is stopped, the internal pressure in the holder 2 is lowered, the valve 16 and the urging spring 20 are elastically returned to the original state, the pressing surface 17a of the opening-closing portion 17 is pressed against the curved surface 5a of the holder 2, and jetting of the fluid from the nozzles 4 is stopped. Then, since the pressure of the fluid is lowered, the spring member is compressed, the piston 21 moves to the rear end of the movement range, that is, the piston moves in the direction in which the piston 21 is pulled into the cylinder 22, and the cover surface portion 9 of the cover 3 closes the opening 100a formed in the bumper 100 (see FIG. 2 and FIG. 3).

In the vehicle cleaning apparatus 1, there is a case where the fluid remains in each of the spaces from the nozzles 4 to the valve 16. Accordingly, in a cold region or the like, the remaining fluid may be expanded, for example, when the remaining fluid is frozen. When the fluid is expanded, a pressure (i.e., internal pressure) in each of the spaces from the nozzles 4 to the valve 16 becomes higher than the atmospheric pressure, the valve 16 moves forward against the urging force of the urging spring 20 (see FIG. 5), and the opening 5b is opened. This allows the fluid to flow toward the rear end of the valve 16.

When the fluid is expanded as described above, the opening 5b is opened such that the fluid is allowed to flow toward the rear end of the valve 16. Thus, the pressure that is applied to each of portions in the valve 16 and the holder 2 is lowered, and thus, damage to or a fracture in the valve 16 or the holder 2 does not occur.

When the fluid is thawed and the pressure in each of the spaces from the nozzles 4 to the valve 16 is lowered, the attached portion 19 and the urging spring 20 are elastically returned to the original state, and the pressing surface 17a of the opening-closing portion 17 is returned to the original state in which the pressing surface 17a is pressed against the curved surface 5a of the holder 2 (see FIG. 2 and FIG. 3).

As it has been described so far, the vehicle cleaning apparatus 1 includes the holder 2. The holder 2 includes the valve disposition portion 5 in which at least a part of the valve 16 is disposed, and the cover attachment portion 6 to which the cover 3 is attached. The cover attachment portion 6 is formed integrally with the valve disposition portion 5 (in other words, the cover attachment portion 6 is integral with the valve disposition portion 5).

Thus, since the valve disposition portion 5, in which the valve 16 is disposed, and the cover attachment portion 6, to which the cover 3 is attached, are integrally formed in the holder 2, a dedicated member to which the cover 3 is attached and a dedicated member in which the valve 16 is disposed are unnecessary. Therefore, the number of the components can be reduced, and the structure can be simplified.

In addition, the holder 2 further includes the piston coupling portion 7 that is coupled to the piston 21. The valve disposition portion 5 and the piston coupling portion 7 are integrally formed (in other words, the valve disposition portion 5 is integral with the piston coupling portion 7).

Thus, a dedicated member to which the cover 3 is attached, a dedicated member in which the valve 16 is disposed, and a dedicated member that is coupled to the piston 21 are unnecessary. Therefore, the number of the components can be further reduced, and the structure can be further simplified.

Furthermore, the holder 2 further includes the nozzle holding portions 8 that hold the nozzles 4, the valve disposition portion 5 and the piston coupling portion 7 are provided to be continuous with each other in the axial direction (the front-rear direction), and the nozzle holding portions 8 are projected from the valve disposition portion 5 in the different direction from the axial direction.

Thus, the direction in which the nozzle holding portions 8 are projected is different from the axial direction in which the valve disposition portion 5 and the piston coupling portion 7 are continuous with each other. Therefore, the size of the vehicle cleaning apparatus 1 in the axial direction can be reduced.

Moreover, the plurality of nozzle holding portions 8 and the plurality of nozzles 4 are provided, and the plurality of nozzle holding portions 8 are projected from the valve disposition portion 5 toward opposite sides in a direction orthogonal to the axial direction.

Thus, since the plurality of nozzles 4 are provided, the fluid can be jetted to a wide area. Therefore, cleaning performance of the vehicle cleaning apparatus 1 can be improved while the size of the vehicle cleaning apparatus 1 in the axial direction can be reduced.

In the vehicle cleaning apparatus 1, a part of the valve 16 is disposed in the piston coupling portion 7.

Thus, the valve 16 is disposed to extend from the valve disposition portion 5 to the piston coupling portion 7 (in other words, a part of the valve 16 is disposed in the valve disposition portion 5 and another part of the valve 16 is disposed in the piston coupling portion 7). Therefore, the size of the valve disposition portion 5 in the axial direction can be reduced, and thus, the size of the vehicle cleaning apparatus 1 in the axial direction can be further reduced.

In addition, the air flow holes 14a, which are formed in the cap 13, are covered by the cover 3. Therefore, dust and moisture that move toward the air flow holes 14a can be blocked by the cover 3, and entry of the dust and the moisture into the holder 2 can be prevented while an appropriate operation state of the valve 16 is secured.

What is claimed is:

1. A vehicle cleaning apparatus comprising:
a nozzle configured to jet fluid toward an object to be cleaned;
a cover configured to cover at least a part of the nozzle;
a valve configured to open and close a channel of the fluid; and
a holder including a valve disposition portion in which at least a part of the valve is disposed, and a cover attachment portion to which the cover is attached, wherein
the cover attachment portion is formed integrally with the valve disposition portion.

2. The vehicle cleaning apparatus according to claim 1, further comprising
a piston which is movable in an axial direction with respect to a cylinder and in which the fluid flows, wherein:
the holder further includes a piston coupling portion that is coupled to the piston; and
the valve disposition portion and the piston coupling portion are integrally formed.

3. The vehicle cleaning apparatus according to claim 2, wherein:
the holder further includes a nozzle holding portion configured to hold the nozzle;
the valve disposition portion and the piston coupling portion are provided to be continuous with each other in the axial direction; and
the nozzle holding portion is projected from the valve disposition portion in a different direction from the axial direction.

4. The vehicle cleaning apparatus according to claim 3, wherein:
a plurality of the nozzle holding portions and a plurality of the nozzles are provided; and
the plurality of the nozzle holding portions are projected from the valve disposition portion toward opposite sides in a direction orthogonal to the axial direction.

5. The vehicle cleaning apparatus according to claim 2, wherein a part of the valve is disposed in the piston coupling portion.

6. The vehicle cleaning apparatus according to claim 1, wherein:
an air flow hole is provided, and outside air is taken into the holder through the air flow hole to cause the valve to operate; and
the air flow hole is covered by the cover.

7. The vehicle cleaning apparatus according to claim 6, wherein:
a cap that closes an opening of the valve disposition portion is attached to an inner peripheral surface of the cover attachment portion; and
the air flow hole is provided in the cap.

8. The vehicle cleaning apparatus according to claim 1, wherein the valve is elastically deformable.
